(19) United States
(12) Patent Application Publication
(10) Pub. No.: US 2016/0339347 A1
(43) Pub. Date: Nov. 24, 2016

(54) Proximity Activated Game Based on Motion

(71) Applicants: Tonatium Adrian Gimate Welsh, Mexico (MX); Manolo Celi, Brooklyn, NY (US)

(72) Inventors: Tonatium Adrian Gimate Welsh, Mexico (MX); Manolo Celi, Brooklyn, NY (US)

(21) Appl. No.: 14/715,922

(22) Filed: May 19, 2015

(51) Int. Cl. A63F 13/92; A63F 13/211; A63F 13/216; A63F 13/73; A63F 13/235; A63F 13/792; A63F 13/355; A63F 13/56; H04L 29/06; A63F 13/25

(52) U.S. Cl. CPC A63F 13/92; H04L 65/403; A63F 13/211; A63F 13/216; A63F 13/25; A63F 13/235; A63F 13/792; A63F 13/355; A63F 13/56; A63F 13/73

(57) ABSTRACT

Embodiments of the disclosed technology are directed to a system and/or method for selectively obscuring a display of a hand-held electronic communications device. At least two devices may be employed by the system and/or method. A first and a second device each have at least one bidirectional transceiver, an accelerometer, and an electronic display. The first and second devices are paired to one another based on their proximity and/or associated users. A plurality of likenesses is displayed on each device. Commands and/or gestures are then carried out on either or both devices to make changes to the appearance of likenesses on each display.

### FIELD OF THE DISCLOSED TECHNOLOGY

The disclosed technology relates generally to wireless communications, and, more specifically, to motion of such devices for entertainment purposes.

### BACKGROUND OF THE DISCLOSED TECHNOLOGY

Social networking has changed the way we communicate with others. Countless numbers of devices exist which grant a user access to the internet, and thus to other users, both near and far. As the way we interact evolves, so do the various devices we use for doing so. Furthermore, improvements in technology allow humans to be connected to the web, no matter where they are located. The most obvious device humans use to stay connected is the mobile phone. Mobile phones with data plans are becoming so common that there are almost as many active mobile phones as there are humans in the world.

Another sector that has evolved along with the improving technology in the field of electronic communication is the online, or mobile, gaming sector. Technology in mobile gaming has evolved from simple computer-based games to worldwide networks of millions of users participating in a single game. Furthermore, mobile games have become popular on mobile devices. Mobile games are easily acquired via a mobile devices data connection. Increasingly, more and more of these games have at least some multi-player element thereto. As such, some of the most widely used mobile games involve multi-player game-play as the prospect of playing with another human garners greater interest from users. Many of these games are tied to social networking platforms and profiles, in order to better connect users.

Geo-social networking is a type of social networking in which geographic services and capabilities are used to enable certain social dynamics. User location data can allow social networks to localize services that they provide to users. For example, services allow location-based social networking that makes possible interaction with mobile devices, such as GPS-enabled mobile devices—for instance smart phones. However, these services rely on discrete check-ins, where a user has to take action to establish his/her location with respect to a landmark. However, many of these location-based social networking utilities only provide a forum facilitating communication, and they are typically tied to a specific location, such as a restaurant or store.

While these references provide a forum through which nearby users may communicate with one another, they do not make the match-making or communication aspects of the application fun and engaging. Thus, there exists a need for a location-based social interaction game by means of which nearby users are matched with one another through an interactive gaming environment.

### SUMMARY OF THE DISCLOSED TECHNOLOGY

Embodiments of the disclosed technology are directed to a system for selectively obscuring a display of a hand-held electronic communications device. At least two devices may be employed by the systems. A first and a second device each have at least one bidirectional transceiver, an accelerometer or gyroscope, and an electronic display. It should further be understood that anywhere in the disclosure the “accelerometer” is mentioned, a “gyroscope” can be used in it's place.

The system may be carried out, not necessarily in the following order, by way of any or all of the following steps: a) receiving data indicating a relative position of the first and the second devices; b) based on the relative position data, determining when the first and the second devices are within a pre-defined distance from one another; c) based on the determining of the pre-defined distance, exhibiting: i) a likeness of a user of the first device on the electronic display of the second device and, ii) a likeness of a user of the second device of the electronic display of the first device; d) obscuring from view each likeness exhibited on the first device and the second device; e) based on movement data outputted by the accelerometer of the first device, at least partially unobscuring the likeness exhibited on the display of the first device; and/or f) sending data to either of the first or second device, the data comprising information indicating that the user of the first device or second device has selected the likeness of the other the user fastest.

In a further embodiment of the disclosed system, each likeness is exhibited on the display among a plurality of likenesses of other people, and a selection of one of the other people further obscures display of the likeness of the first or second user. Still further, the obscuring may be carried out by way of including additional likenesses of people on the display of one of the electronic devices.

In still further embodiments, obscuring of the display of the first device is carried out by way of displaying pixelated content covering at least a majority of the electronic display. Movement of the pixelated content may reveal at least part of the plurality of likenesses. The movement of the pixelated content may be based on detection of motion by a touch-screen of the electronic display and/or the accelerometer. Further, the pixelated content may move corresponding to a vector defining a direction of the motion.

Alternatively, detected motion by the accelerometer in opposite directions in three-dimensional space within a pre-defined time period may remove at least some of the distorting. In another alternative embodiment, obscuring may be carried out by way of placing at least one item over the plurality of likenesses which are moved, with respect to the plurality of likenesses based on an orientation change of the first device, as determined by output of the accelerometer. In another embodiment, the obscuring is carried out by way of, at regular or irregular time intervals, varying a position of exhibiting on the display for at least one likeness of the plurality of likenesses, until a touch-screen detects that the display has been touched at a present position of at least one of the plurality of likenesses whose position was varied.

In other embodiments, the obscuring may be carried out by way of, at regular or irregular time intervals, varying a position of exhibiting on the display for at least one likeness of the plurality of likenesses, until a touch-screen detects that the display has been touched at a present position of at least one of the plurality of likenesses whose position was varied. Alternatively, motion in a circular direction may be detected within a pre-defined time period and removes at least some of the distorting. Also, the plurality of likenesses of other people exhibited may be increased or decreased in number in response to the input from the first user.

In still another embodiment, the system may have at least three hand-held wireless communication devices, each device being associated with a user. In this embodiment, a device on which a user fails to select the likeness of the other, the fastest user is excluded from the steps of exhibiting and obscuring until either all but one remaining device of the at least three such hand-held wireless communication devices are associated with a user who fails to select the likeness or the user of the device on which the user fails to select the likeness pays money to an operator of the game.

In another embodiment of the disclosed technology, a method is used for facilitating proximity-based social interaction and identification amongst two or more users. The method is carried out, not necessarily in the following order, by: a) receiving a participation request from at least a first hand-held device of a first user and a second hand-held device of a second user located within a proximity; b) matching the first user with the second user based on at least one search criterion; c) displaying a visualization of a plurality of faces on displays of the first and the second hand-held device, wherein one of the faces on the first device is associated with the second user, and one of the faces on the second device is associated with the first user; d) receiving data representative of a command sent from the first user to the second user, wherein the command alters the visualization displayed on the second device; e) receiving a response from the second device that is generated based on the second user performing a gesture with respect to the second device, wherein a correct gesture, as indicated by one or more components of the second device, counteracts the altering of the visualization; and/or f) declaring a winner upon successful identification of the face of one of the users by the other.

In further embodiments of the disclosed method, altering of the visualization may be by way of obscuring one or more of the faces. Further, the gesture may involve moving the device in a specific pattern, such as, for example, making a circular clockwise motion. An accelerometer of the device may be employed to detect whether the gesture has been carried out correctly. Alternatively, the gesture may be a touch pattern performed on the display of the device. For example, the user may be required to use the accelerometer to move an electronic ball through a maze and into a goal on the display.

In a further embodiment of the disclosed technology, the eliminated user may buy his or her way back into the game. The user may use electronic currency or real currency to pay a fee to be reinstated into the game.

“Substantially” and “substantially shown,” for purposes of this specification, are defined as “at least 90%,” or as otherwise indicated. Any device may “comprise” or “consist of” the devices mentioned there-in, as limited by the claims.

It should be understood that the use of “and/or” is defined inclusively such that the term “a and/or b” should be read to include the sets: “a and b,” “a or b,” “a,” “b.”

### BRIEF DESCRIPTION OF THE DRAWINGS

FIG. 1 shows an example of a visualization of a plurality of likenesses, according to embodiments of the disclosed technology.

FIG. 2 shows an obscured version of the visualization of FIG. 1.

FIG. 3 shows a less obscured version of the visualization of FIG. 1 with fewer likenesses shown.

FIG. 4 shows a less obscured version of the visualization of FIG. 1 with more likenesses shown.

FIG. 5 shows a high level diagram of a proximity-based interaction system, according to embodiments of the disclosed technology.

FIG. 6 is a flow chart showing a method of playing the game, in embodiments of the disclosed technology.

FIG. 7 shows dust on a display screen and directions of movement thereof to remove the dust, in a combination of various embodiments of the disclosed technology.

FIG. 8 shows a high-level block diagram of a device that may be used to carry out the disclosed technology.

### DETAILED DESCRIPTION OF EMBODIMENTS OF THE DISCLOSED TECHNOLOGY

Embodiments of the disclosed technology are directed to a system and/or method for selectively obscuring a display of a hand-held electronic communications device. At least two devices may be employed by the system and/or method. A first and a second device each have at least one bidirectional transceiver, an accelerometer, and an electronic display. The first and second devices are paired to one another based on their proximity and/or associated users. A plurality of likenesses is displayed on each device. Commands and/or gestures are then carried out on either or both devices to make changes to the appearance of likenesses on each display.

Based on the above, users are entered into a game. Many users may be entered into this game, each having a hand-held wireless transceiver. The game rules proceed as follows:
register/enter into the game;
select your picture for display, showing a likeness of you (an alternate embodiment can use any icon or picture of your choice);
the game is set with a certain proximity, as determined by a game administrator for this particular game (one of the players), or overall settings provided in advance by a provider of the game (a person with operative control over a server, where game instructions are stored or carried out in a manner required for the game to function);
when another player in the game is detected as being within a certain proximity (which can be line of sight, within the same room, or within a pre-defined distance as detected by any of an infrared sensor, wireless transceiver (e.g., 802.11 network connection or cellular network connection and/or location determination), Bluetooth (short range (<10 meter) wireless communication) or other geo-location methods known in the art (e.g., global positioning system), the players battle.
In a “battle,” a grid comprising pictures of users in the game are shown (and can include additional pictures), and the first user to select the picture of the other user wins the round. The losing user is out of the game.
Users can “attack” other users, which is defined as making it more difficult for the other user to find his/her picture by obscuring the display of the other user (and also the buttons or selectors for attacking).
Users can “defend” by nun-obscuring their screen to view the grid, or making the likenesses larger/displaying less of them.
When a user loses the game, he/she needs to wait until the next game starts, or he/she can pay into a pot for the winner of the game or to the game administrator (as defined above) to have another chance in the game.

Embodiments of the disclosed technology will become clearer in view of the following discussion of the figures.

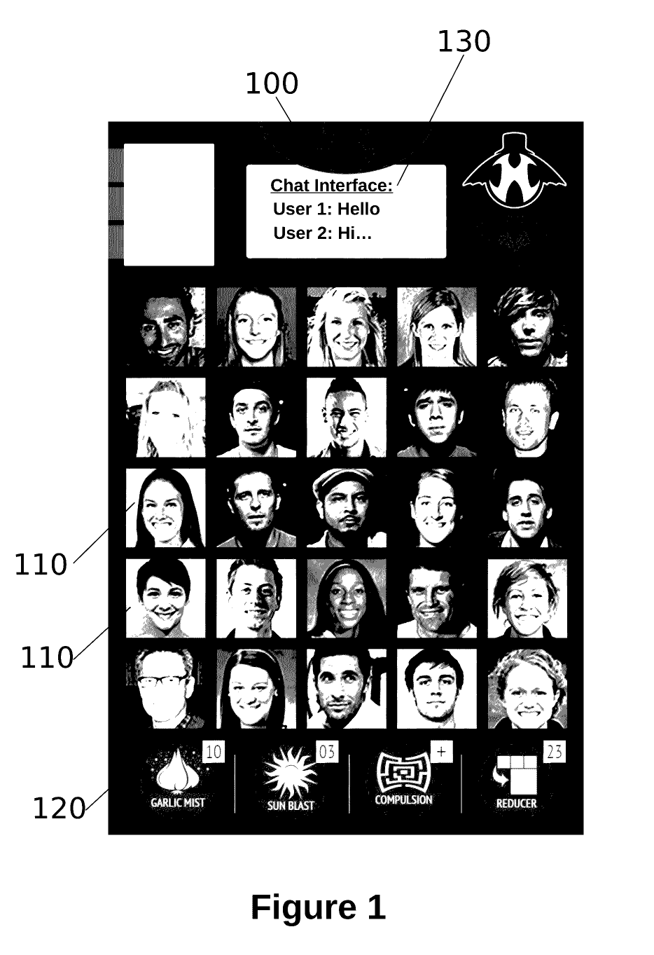

FIG. 1 shows an example of a visualization of a plurality of likenesses, according to embodiments of the disclosed technology. The visualization 100 is electronically generated, such that it may be displayed on a screen of a mobile device, computer, tablet, e-reader and/or any other electronic device. The visualization 100 shows a plurality of likenesses 110 of individuals. A “likeness,” for purposes of this specification, is defined as a semblance, guise, outward appearance, portrait, representation, or avatar representing an individual, a group of individuals, or an entity. As such, a likeness may simply be a photograph of an individual, such as those shown in FIG. 1. All of the portraits depicted in FIG. 1 may be of other participants using the disclosed technology. The participants may be located in a specific geographic area. In other embodiments, the “likeness” is any picture or picture of an object chosen by or representative of a person. This can be a cartoon character, a picture of their phone, a picture of their logo, favorite place to eat, or the like.

The visualization depicted in FIG. 1 is an example of what may be displayed on a user's mobile device screen upon initiating an application or service provided under the disclosed technology. Thus, for example, a first user and a second user, who are located within a given proximity, unbeknownst to one another, may initiate the application, game, or service on his/her mobile device, where “proximity,” for purposes of this specification, is defined as a specified radius or distance between two or more mobile devices associated with two or more corresponding users. For example, the proximity may be set to five miles, whereby users will be matched to other users within five miles. Any conceivable distance or radius may be used, and the distance may vary based on the number of users in a given geographic location.

Users of the game can sneak up on each other causing a battle to begin, or a battle can start randomly or pseudo-randomly when in proximity, so that the two people will not be aware of just when a battle will start. This is particularly useful, for example, in an office or single large building where users of the game often cross paths. They may not even be aware, for example, when there are many people playing the game, which user they are battling when there are other players near them. They might look around to see who else is using a phone, or from where a sound has emanated, signaling to another that the battle has started. Or, multiple battles may start at once when there are a lot of users of the game in proximity to each other. Thus, they may not know with which of the other players they are actually in a battle, even when the person is standing next to them.

Referring still to the visualization 100, a chat interface 130 may be provided which allows the users to communicate, without revealing their actual identities. The chat interface 130 that may be toggled by either user can be lacking in some embodiments. The buttons 120 are attacks and defenses which can be used. Attacks obscure the screen of the other user, including, in embodiments, by adding more faces to the grid. Defenses un-obscure the screen of the present user and/or prevent an attack from being carried out or lessen its impact. For example, if the attack adds likenesses to the other's screen (a form of obscuring, decreasing the grid/picture sizes) the defense may remove some or all of the additional likenesses.

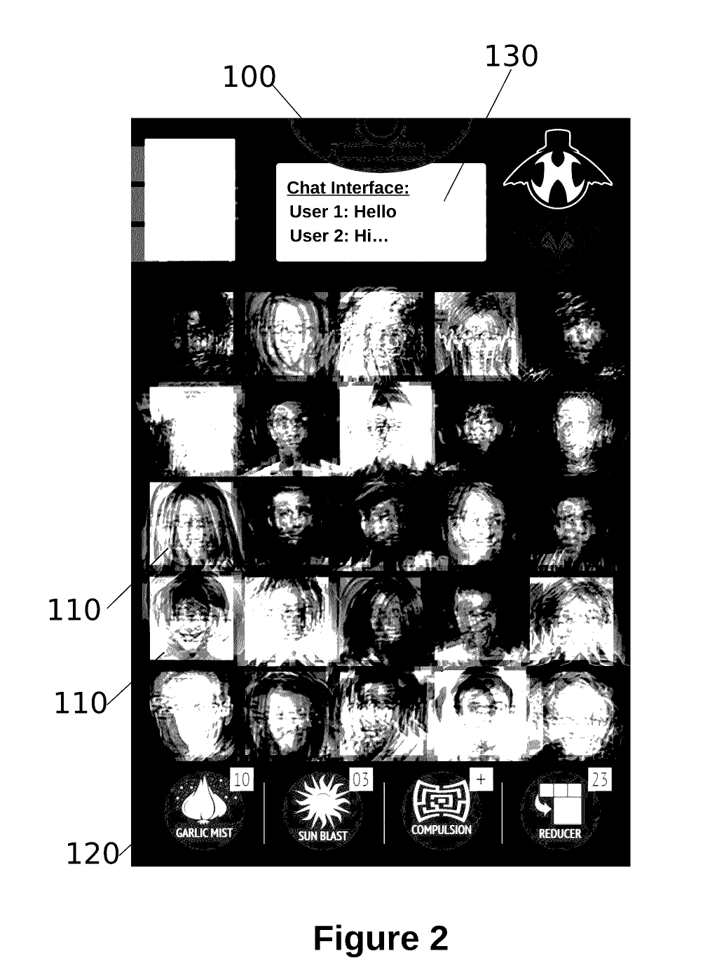

FIG. 2 shows an obscured version of the visualization of FIG. 1. Here, the likenesses are blurred in an attack. In embodiments, the attack/defense buttons 120 may also be blurred, making it harder to use same. The attack/defense buttons displayed may be randomly selected from those available to a user, may be purchased, or may have been won in prior games. Another attack may consist of disabling one or more of the other user's buttons, limiting their attack/defense ability for a set amount of time or the round.

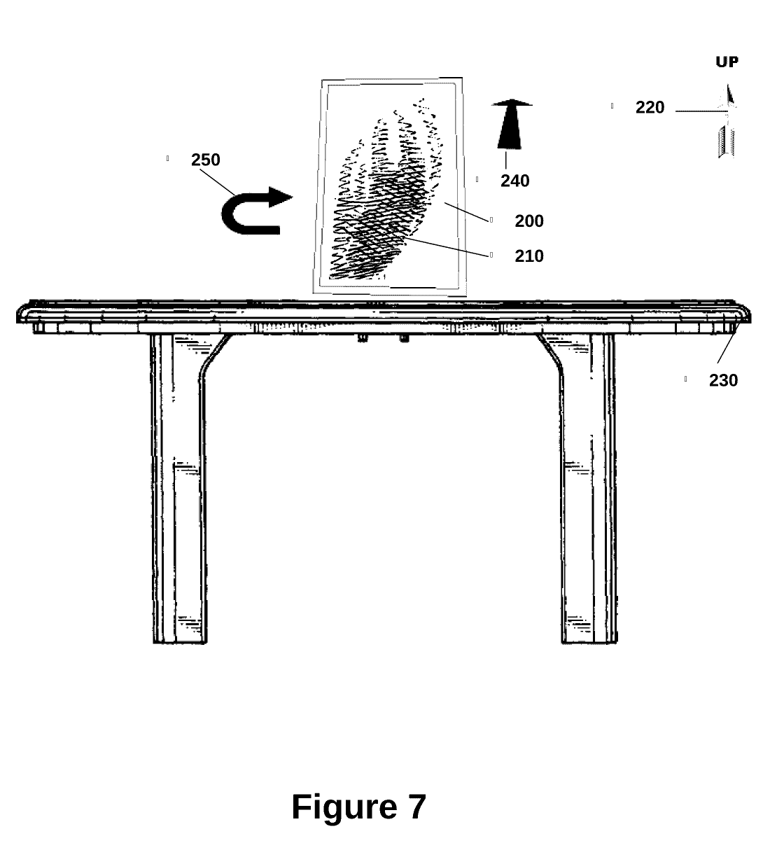

Skipping to FIG. 7, another attack may be to cover the screen partially or fully in dust (defined as being at least 50+ separately movable pixels, movable by way of interacting with a touch screen, each being no more than 1/10th the size of a likeness of the individuals displayed, the pixels being independently movable or “pixelated”) such that they are obscured. In another embodiment of an attack, the grid of likenesses 110 may be re-arranged. In yet another embodiment, such as the example shown in FIG. 2, the likenesses may become visually distorted, such that they are partially or wholly unrecognizable. In still another embodiment, the likenesses can appear to “melt” slowly.

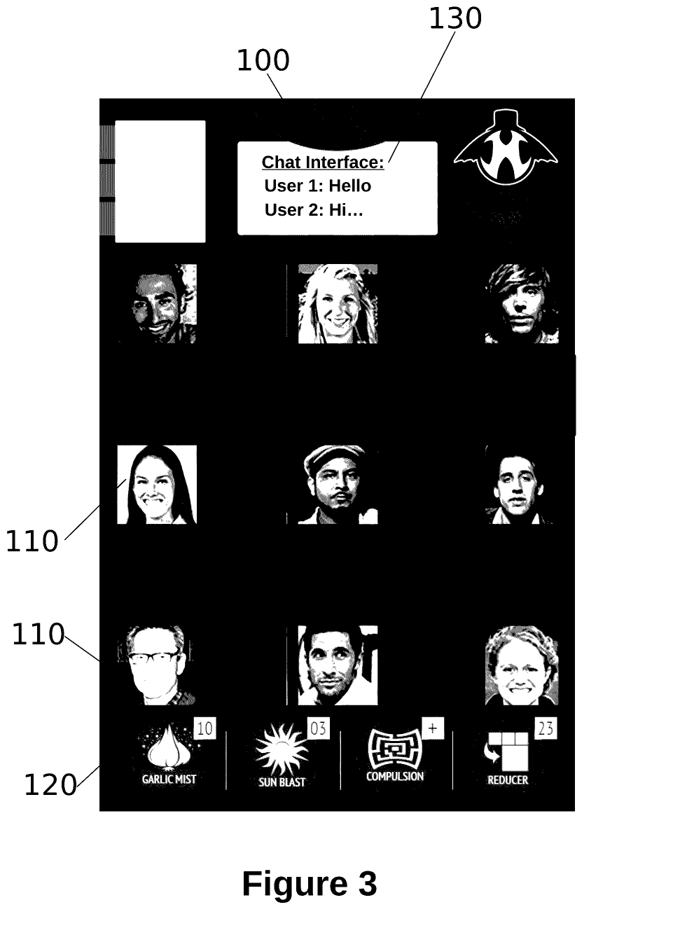

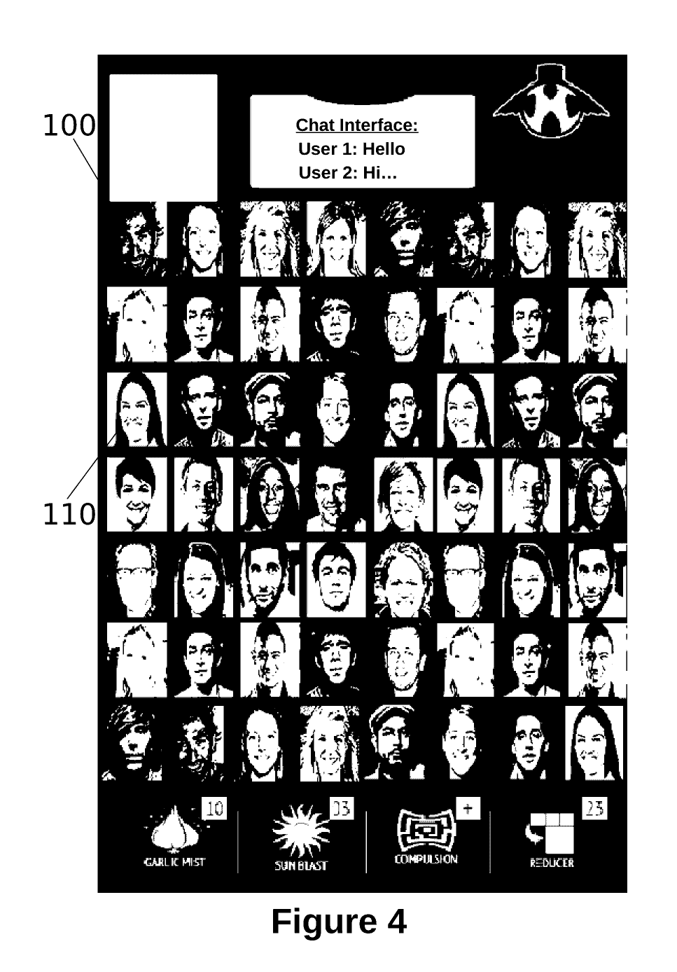

FIG. 3 shows the visualization of FIG. 1, with the number of likenesses reduced. FIG. 3 depicts the number of likenesses 110 being reduced from 25 to 9. FIG. 4 shows the visualization of FIG. 1 with the number of likenesses increased. These concepts have been described in more detail with respect to FIG. 1.

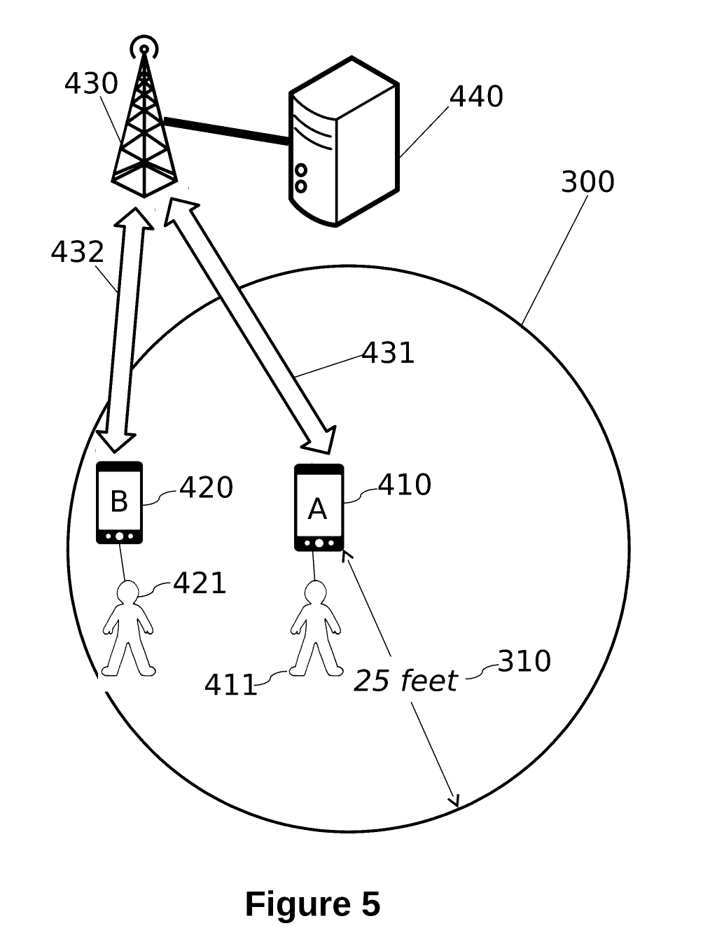

FIG. 5 shows a general overview of a proximity-based interaction system, according to one or more embodiments of the disclosed technology. A geographic area 300 is depicted in FIG. 5. In the example shown, the geographic area 300 has a radius 310 of 25 feet. The geographic area 300 represents the “proximity” of the first mobile transceiver device 410 carried by the first user 411. Thus, the geographic area 300 is all points within 25 feet of the first mobile device 410 and, in turn, the first user 411. As such, given a proximity of one mile, when the first user 411 searches for an opponent, a command 431 is sent via a wireless hardware switch or router 430 connected to the first user, in turn, to a server 440. Another user is then sought within the radius, in this case, 25 feet, of the first device 410.

In the example shown, a second device 420 associated with a second user 421 may have also been seeking an opponent via a command 432. As such, the server 440 matches the two opponents, the first user 411 and the second user 421, to one another. The wireless provider 430 and the server 440 act as an intermediary between the two users in this embodiment. Once matched, the users may carry out an identification game among themselves, according to embodiments of the disclosed technology. It should be noted that each user 410, 420 may be anywhere on a packet-switched network comprising multiple switches, hubs, routers, and gateways operated by one or more companies collectively referred to as the “internet” (open network), an “intranet” (closed access network), or combination of internet and intranet. The wireless devices may also communicate directly with one another by way of a wireless transmission in the form of radio (e.g., BlueTooth) or infrared. Using the BlueTooth protocol known in the art, one can also measure distance of other devices and look up with a server to determine if the other device is part of the game.

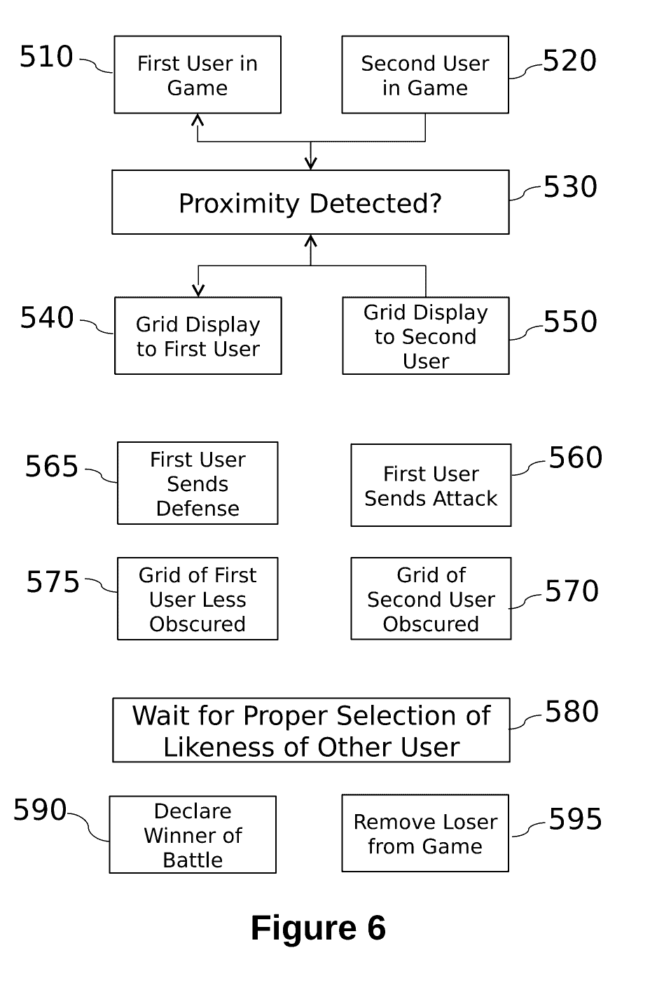

FIG. 6 is a flow chart showing a method of playing the game, in embodiments of the disclosed technology. In FIG. 6, it is already assumed that users have been entered into a game and have paid an entry fee, if required. Here, a first user 510 and a second user 520 are two people within the game, each using his or her own hand-held wireless transceiver. When the players are in close proximity to each other, in step 530 this is detected, and a battle ensues. A grid of players, or players and non-players, is shown on each screen, such as shown in FIG. 1, 2, 3, or 4. As recited above, the users may immediately know which other user they are battling by hearing a sound indicating the game has begun on the other user's device, or by seeing the other user, such as in a line of sight game. This can be combined with other games, such as paint ball, man hunt, or capture the flag, as a method of enchaining the game and having another way to get your opponents out on the other team. In any case, each user must select the likeness of the user he/she is battling, on his/her display screen, in order to win the round.

In embodiments, attacks and/or defenses are used (defined and described above). As shown in FIG. 6, the first user sends a defense in step 565, and his grid becomes less obscured in step 575. In addition, or instead, the first user might send an attack in step 560, causing the grid of the second user to become more obscured in step 570. It should be understood that the second user could do likewise, having the effect described on the opposite party in steps 570 and 575.

Once a proper selection of a likeness of the other user in a game is selected in step 580, then a winner is declared in step 590. Now, the loser of the battle is out of the entire game until the game restarts, in step 595. The loser can buy his/her way back in by adding more money to the pot of the winner and/or paying the game administrator. The winner can receive additional or stronger attacks and/or defenses to use in future battles.

FIG. 7 shows dust on a display screen and directions of movement thereof to remove the dust, in a combination of various embodiments of the disclosed technology. Here, a table 230 is shown for the purpose of helping describe the orientation of the hand-held wireless transceiver 200. The “up” direction 220 is as shown on the plane of FIG. 7. On the display screen, dust 210 is shown obscuring the view of likenesses of players in the game which are “beneath” the dust. By moving the dust, the likenesses are revealed. The dust is a form of attack on the player, which obscures the view of the likenesses, as well as, in some embodiments, the buttons to use for defenses and attacks.

Different attacks may require different actions to unobscure the display and/or more clearly show the likenesses of the individuals on the grid. For example, one may have to shake the screen vigorously, as detected by an accelerometer in the device 200, or may have to tilt the screen 240 backwards or forwards to remove/move “water” and restore the ability to select an item on the screen, or may have to rotate/spin the screen 250 on an axis around the viewing direction to “spin” items off the likenesses by way of centrifugal force. Other attacks may require a user to level the screen. Still others require wiping away particulate matter, such as dust 210, as shown to reveal the faces to select.

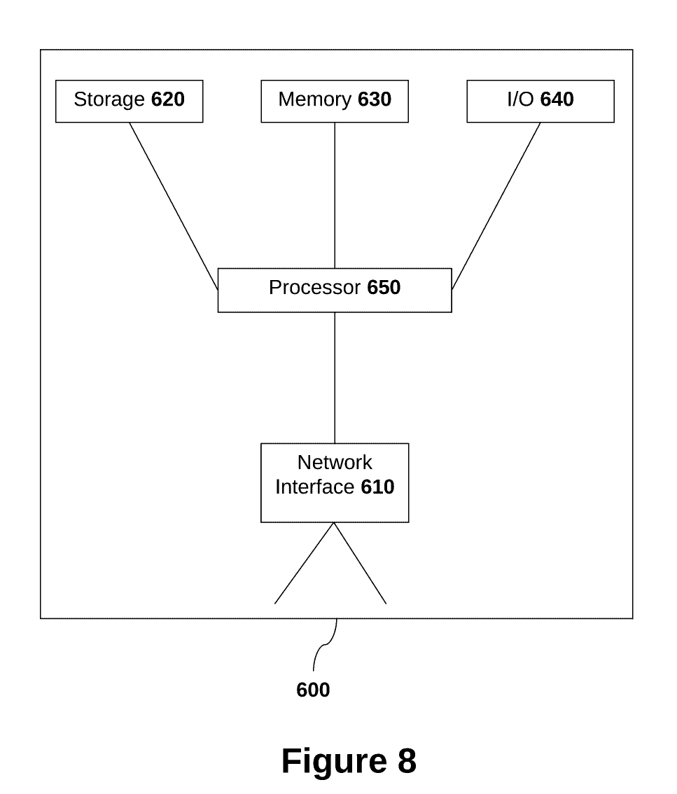

FIG. 8 shows a high-level block diagram of a device that may be used to carry out the disclosed technology. Device 600 comprises a processor 650 that controls the overall operation of the computer by executing the device's program instructions which define such operation. The device's program instructions may be stored in a storage device 620 (e.g., magnetic disk, database) and loaded into memory 630 when execution of the console's program instructions is desired. Thus, the device's operation will be defined by the device's program instructions stored in memory 630 and/or storage 620, and the console will be controlled by processor 650 executing the console's program instructions. A device 600 also includes one or a plurality of input network interfaces for communicating with other devices via a network (e.g., the internet). The device 600 further includes an electrical input interface.

A device 600 also includes one or more output network interfaces 610 for communicating with other devices. Device 600 also includes input/output 640 representing devices which allow for user interaction with a computer (e.g., display, keyboard, mouse, speakers, buttons, etc.). One skilled in the art will recognize that an implementation of an actual device will contain other components as well, and that FIG. 6 is a high level representation of some of the components of such a device for illustrative purposes. It should also be understood by one skilled in the art that the method and devices depicted in FIGS. 1 through 7 may be implemented on a device such as is shown in FIG. 8.

It should further be understood that items used in wireless communication and networks can be used to carry out the methods. These include any types of computing devices, servers, network hardware (routers, switches), handheld electronic devices with display screens, and cables which electronically couple two devices over which electric current and/or data can be sent. Wireless transmission and receiving devices can also be used to send/receive data. The data can be sent via a packet-switched network (data broken into individual pieces, sent, and re-joined into at the site of the recipient) or circuit-switched network (dedicated path for linear flow of data).

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the invention.

1. A system for selectively obscuring a display of a hand-held electronic communications device, wherein each of a first and second said device comprises at least one bidirectional transceiver, an accelerometer, and an electronic display, the system carried out by way of:
receiving data indicating a relative position of said first and said second devices;
based on said relative position data, determining when said first and said second devices are within a pre-defined distance from one another;
based on said determining of said pre-defined distance, exhibiting:
a likeness of a user of said first device on said electronic display of said second device; and
exhibiting a likeness of a user of said second device of said electronic display of said first device;
obscuring from view each said likeness exhibited on said first device and said second device;
based on movement data outputted by said accelerometer of said first device, at least partially unobscuring said likeness exhibited on said display of said first device;
sending data to one of said first device or said second device, said data comprising information indicating that said user of said first device or said second device has selected said likeness of the other said user fastest.

2. The system of claim 1, wherein each said likeness exhibited is exhibited on said display among a plurality of likenesses of other people and a selection of one of said other people further obscures display of said likeness of said first or said second user.

3. The system of claim 1, wherein said obscuring is carried out by way of including additional likenesses of people on said display of one of said electronic devices.

4. The system of claim 2, wherein, referring to said first device, obscuring is carried out by way of displaying pixelated content covering at least a majority of said electronic display, and
movement of said pixelated content reveals at least part of said plurality of likenesses,
wherein said movement of said pixelated content is based on detection of motion by a touch-screen of said electronic display and/or said accelerometer and said pixelated content moves corresponding to a vector defining a direction of said motion.

5. The system of claim 2, wherein, referring to said first device, obscuring is carried out by way of distorting said plurality of likenesses; and
detected motion by said accelerometer in opposite directions in three-dimensional space within a pre-defined time period removes at least some of said distorting.

6. The system of claim 2, wherein, referring to said first device, obscuring is carried out by way of placing at least one item over said plurality of likenesses, which are moved, with respect to said plurality of likenesses, based on an orientation change of said first device, as determined by output of said accelerometer.

7. The system of claim 2, wherein, referring to said first device, obscuring is carried out by way of, at regular or irregular time intervals, varying a position of exhibiting on said display for at least one likeness of said plurality of likenesses, until a touch-screen detects that said display has been touched at a present position of said at least one of said plurality of likenesses whose position was varied.

8. The system of claim 2, wherein, referring to said first device, obscuring is carried out by way of distorting said plurality of likenesses; and
detected motion by said accelerometer in a circular motion within a pre-defined time period removes at least some of said distorting.

9. The system of claim 2, wherein, referring to said first device, said plurality of likenesses of other people exhibited is increased or decreased in number in response to input from said first user.

10. The system of claim 1, wherein said system comprises at least three such hand-held wireless communication devices each associated with a user,
a device on which a user fails to select said likeness of the other said user fastest is excluded from said steps of exhibiting and obscuring until either:
all but one remaining device of said at least three such hand-held wireless communication devices are associated with a user who fails to select said likeness; or
said user of said device on which said user fails to select said likeness pays money to an operator of said game.

11. A method for facilitating proximity-based social interaction and identification amongst two or more users, the method comprising:
receiving a participation request from at least a first hand-held device of a first user and a second hand-held device of a second user located within a proximity;
matching said first user with said second user based on proximity to each other, as determined based on receipt of data via a hardware network node;
displaying a visualization of a plurality of faces on displays of said first and said second handheld device, wherein one of said faces on said first device is associated with said second user, and one of said faces on said second device is associated with said first user;
receiving data representative of a command sent from said first user to said second user, wherein said command alters said visualization displayed on said second device;
receiving a response from said second device that is generated based on said second user performing a gesture with respect to said second device, as determined by a touch sensitive screen and/or an accelerometer, wherein a correct gesture at least partially undoes said altering of said visualization; and
declaring a winner upon successful identification of a said face of one of said users by the other said user.

12. The method of claim 11, wherein said altering of said visualization involves obscuring at least one of said faces exhibited in said visualization.

13. The method of claim 11, wherein said gesture is deemed correct only after moving said device in a specific pattern.

14. The method of claim 13, wherein a processor receives output from an accelerometer of said device and detects whether said specified pattern is correctly carried out, based on said output of said accelerometer.

15. The method of claim 14, wherein said pattern comprises rotating said mobile devices on a surface corresponding to effects of centrifugal force moving items in said display.

16. The method of claim 11, wherein obscuring is carried out by way of, at regular or irregular time intervals, varying a position of exhibiting on said display for at least one likeness of said plurality of likenesses until a touch-screen detects that said display has been touched at a present position of said at least one of said plurality of likenesses whose position was varied.

17. A method for facilitating proximity-based social interaction and identification amongst two or more users, the method comprising:
receiving a participation request from at least a first hand-held device of a first user and a second hand-held device of a second user located within a proximity;
matching said first user with said second user based on proximity to each other, as determined based on receipt of data via a hardware network node;
displaying a visualization of a plurality of faces on displays of said first and said second handheld device, wherein one of said faces on said first device is associated with said second user, and one of said faces on said second device is associated with said first user; and
declaring a winner upon successful identification of a said face of one of said users by the other said user.
